(19) United States
(12) Patent Application Publication
(10) Pub. No.: US 2024/0026802 A1
(43) Pub. Date: Jan. 25, 2024

(54) LEADING EDGE PROTECTOR

(71) Applicant: General Electric Company, Schenectady, NY (US)

(72) Inventors: Nicholas Direnzi, Cincinnati, OH (US); Bernard J. Renggli, Cincinnati, OH (US)

(21) Appl. No.: 17/868,063

(22) Filed: Jul. 19, 2022

(51) Int. Cl. F01D 25/24; F01D 25/28

(52) U.S. Cl. CPC F01D 25/24; F01D 25/28; F05D 2220/323; F05D 2240/14; F05D 2250/75; F05D 2260/31

(57) ABSTRACT

A protector for attachment to and protection of a leading edge of a protective liner of an aircraft engine component includes a clip portion including a channel for receiving a portion of the protective liner including the leading edge of the protective liner. The clip portion includes at least one spacer extending therefrom to create at least one air flow gap between the clip portion of the protector and an upstream liner of the aircraft engine when the upstream liner is positioned in abutment with the at least one spacer of the clip portion. The protector includes a flange portion extending from the clip portion and including a through aperture configured to receive a portion of a fastener passing through both the aperture and at least a portion of the protective liner to attach the protector to the protective liner.

### GOVERNMENT INTERESTS

This invention was made with United States Government support under FA8650-09-D-2922 awarded by the Department of Defense. The Government has certain rights to this invention.

### TECHNICAL FIELD

These teachings relate generally to jet engines and, more particularly, to leading edge protectors for a component thereof.

### BACKGROUND

Turbine engines, and particularly gas or combustion turbine engines, are rotary engines that extract energy from a flow of combusted gases passing through the engine onto a multitude of turbine blades. Exhaust from combustion flows through a high-pressure turbine and a low-pressure turbine prior to leaving the turbine engine through an exhaust nozzle. The exhaust gas mixture passing through the exhaust nozzle is at extremely high temperatures and transfers heat to the components of the turbine engine, including the exhaust nozzle, which is typically metallic. The high temperature environment present within the exhaust nozzle necessitates the use of materials and components that can withstand such an environment.

### BRIEF DESCRIPTION OF THE DRAWINGS

Described herein are embodiments of methods of attaching a protective device to a leading edge of a protective liner of a metal component of an aircraft engine. This description includes drawings, wherein:

FIG. 1 is a perspective front view of a leading edge protector for protecting a forward-facing surface of an engine component;

FIG. 2 is a perspective bottom view of the leading edge protector of FIG. 1;

FIG. 3 is a perspective front view of a portion of a protective liner of an exhaust nozzle of an aircraft engine, including a plurality of leading edge protectors of FIG. 1;

FIG. 4 is a partial cross-section elevational view of a leading edge protector of FIG. 1.

FIG. 5 is a partial cross-section elevational view of a leading edge protector of FIG. 1, but shown being attached by a fastener alternative to that shown in FIG. 4;

FIG. 6 is a front elevational view of the leading edge protector of FIG. 2, where an upstream protective liner is placed into abutment with the spacers of the leading edge protector; and

FIG. 7 is a flow chart diagram of a process of installing the leading edge protector of FIG. 1 in an aircraft engine.

Elements in the figures are illustrated for simplicity and clarity and have not been drawn to scale. The dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of this disclosure. Certain actions and/or steps may be described or depicted in a particular order of occurrence while those skilled in the art will understand that such specificity with respect to sequence is not actually required.

The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

As used herein, the terms “first,” “second,” and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. The approximating language may refer to being within a +/−1, 2, 4, 5, 10, 15, or 20 percent margin in either individual values, range(s) of values, and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In the aviation industry, there is a desire for components that are made of lighter materials rather than conventional metal materials. Ceramics and their composites such as ceramic matrix composites (CMCs) provide a lightweight material option that is durable at various temperatures and thus desirable for incorporation into aircraft engines.

Conventional techniques for protecting metallic/non-metallic aircraft components at high temperatures include attaching a protective liner directly to the metallic/non-metallic aircraft component to be protected (e.g., metallic duct of an exhaust nozzle of the aircraft engine). Other techniques include attaching a ceramic matrix composite (CMC), a polymer matrix composite (PMC) protective liner to the aircraft component to be protected, since the CMC/PMC materials are lighter and is capable of withstanding higher temperatures than the typical metallic protective liner. However, exposure of the leading edge of a protective (e.g., CMC) liner to direct impingement airflow in a high temperature environment (present, for example, in an exhaust nozzle of an aircraft engine) can potentially deform/distress the leading edge of the protective liner, causing delamination of portions of the protective liner from the aircraft component the protective liner is protecting. Notably, a ceramic matric composite protective liner provides significant weight savings over a comparable metallic protective liner, but has very poor wear characteristics, and does not hold up well when exposed to direct flow impingement at its forward-facing edge, and has poor dimensional stability for critical cooling flow gaps.

Since the leading edge of a CMC liner protecting an interior of an exhaust nozzle is subjected to a high temperature environment direct air flow impingement, and since the high temperature fluids/gases can potentially deform/distress the leading edge of the CMC liner, the present disclosure provides a solution for protecting the leading edge of the CMC liner from the direct airflow impingement-caused deformation and/or delamination from the metal exhaust nozzle duct. In particular, embodiments of a leading edge protector 30 described herein protect the leading, i.e., forward-facing edge of the CMC liner 20 against direct contact with high temperature gases/fluids, thereby protecting the CMC liner 20 from deterioration and/or delamination that may otherwise be cause by direct airflow impingement-caused at the high temperatures present in aircraft engines.

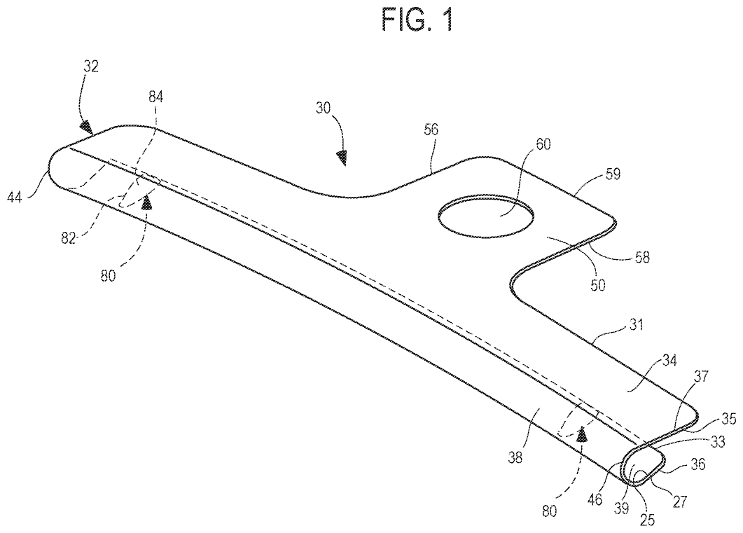

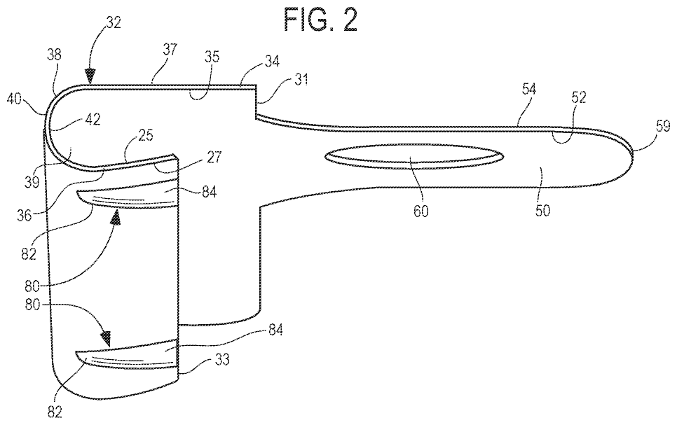

FIG. 1 illustrates an exemplary embodiment of a leading edge protector 30 for protecting a forward-facing or leading edge 22 of a protective liner 20 (e.g., an aircraft engine protective liner), which may be a CMC material, a PMC material, or the like, as mentioned above. In the embodiment illustrated in FIG. 1, the leading edge protector 30 includes a clip portion 32 that is sized and shaped such that it can slide onto and attach (e.g., via a friction fit) to the leading edge 22 of the protective liner 20. The exemplary leading edge protector 30 includes an upper or first wall 34, a lower or second wall 36, and a front or third wall 38 interconnecting the first wall 34 and the second wall 36. FIG. 2 shows that the first wall 34, third wall 38, and second wall 36 of the leading edge protector are oriented and shaped such that they are generally U-shaped (or C-shaped) and define a channel 39 therebetween.

As shown in FIG. 2 and as will be discussed below, the channel 39 of the leading edge protector 30 is sized and shaped to receive the leading edge 22 and the adjacent portion of the protective liner 20. Notably, the shape of the channel 39 is shown in FIG. 2 by way of example only, and the channel 39 is not limited to this specific shape and is not drawn to scale.

In the embodiment shown in FIGS. 1 and 2, the third wall 38 has an outwardly-facing or first surface 40 and an inwardly-facing or second surface 42 that are both at least in part curved in a direction from a first side 44 of the clip portion 32 to a second side 46 of the clip portion 32 to complement the exterior curvature of the leading edge 22 of the protective liner 20. As can be seen in FIG. 2, the outwardly-facing surface 40 is generally convex while the inwardly-facing surface 42 is generally concave. In some embodiments, a maximum dimension of the clip portion 32 is defined by a distance from the first side 44 of the clip portion 32 to the second side 46 of the clip portion 32, and the maximum dimension of the clip portion 32 may be application-specific and may depend, for example, on the overall circumference of the protective liner 20 to which the leading edge protector 30 is to be attached. With reference to FIG. 1, the aforementioned channel 39 of the clip portion 32 extends from the first side 44 of the clip portion 32 to the second side 46 of the clip portion 32.

With reference to FIG. 2, the first wall 34 of the leading edge protector 30 has an inwardly-facing or first surface 35 that abuts and contacts the outwardly-facing or first surface 21 of the protective liner 20, and an outwardly-facing or second surface 37 opposite first surface 35. In some embodiments, the thickness of the first wall 34 is defined by the distance between the first surface 35 and the second surface 37 and this thickness may vary based on the needs of a specific installation, and may be, for example, from 5-100 mils (i.e., thousands of an inch). Similarly, the second wall 36 of the leading edge protector 30 has first surface 25 that abuts and contacts the first surface 21 of the protective liner 20, and a second surface 27 opposite the first surface 25.

In some embodiments, the thickness of the second wall 36 is defined by the distance between the first surface 25 and the second surface 27 and this thickness may vary based on the needs of a specific installation and may be, for example, from 5-100 mils (i.e., thousands of an inch). With reference to FIG. 2, the body 29 of the leading edge protector has a first (inwardly-facing) surface that is defined by the surfaces 25, 35, and 42 and a second (outwardly-facing) surface that is defined by the surfaces 27, 37, and 40.

With reference to FIGS. 1-2, the leading edge protector 30 has a body 29 that includes a flange portion 50 extending from the clip portion 32. In some embodiments, the clip portion 32 and the flange portion 50 are unitarily formed as a single monolithic structure. The flange portion 50 of the body 29 may have a generally rectangular shape as shown in FIG. 1, but it will be appreciated that the flange portion 50 and/or the body 29 in general may have another linear and/or rounded shape. In the illustrated embodiment, the body 29 is contoured such that the flange portion 50 includes a first surface 52 and a second surface 54 that are both at least in part curved in a direction from a first side 56 of the flange portion 50 to a second side 58 of the flange portion 50 to complement the exterior curvature of the protective liner 20.

In some embodiments, the thickness of the flange portion 50 is defined by the distance between the first surface 52 of the flange portion 50 and the second surface 54 of the flange portion 50, and this thickness may vary based on the needs of a specific installation and may be, for example, from 5-100 mils (i.e., thousands of an inch). It will be appreciated that the thickness of the first wall 34 and the clip portion 32 does not have to be constant as shown in FIG. 2, and may vary from front to back (e.g., some portions of the first wall 34 and/or clip portion 32 may be thicker and some portions of the first wall 34 and/or clip portion 32 may be thinner).

As can be seen in FIGS. 1 and 2, the flange portion 50 includes an opening or aperture 60 extending therethrough that defines apertures in both the second surface 54 and the first surface 52 of the flange portion 50. The aperture 60 is illustrated in FIGS. 1-2 as having a generally oval shape, but it will be appreciated that the flange portion 50 may include a differently-shaped (e.g., circular, rectangular, etc.) aperture 60.

With reference to FIGS. 1-2, the first wall 34 of the clip portion 32 has a maximum length defined by a distance from the third wall 38 to a free distal end 31 of the first wall 34. Similarly, the second wall 36 of the clip portion 32 has a maximum length defined by a distance from the third wall 38 to a free distal end 33 of the second wall 36. As can be seen in FIG. 1, the maximum length of the first wall 34 is greater than the maximum length of the second wall 36.

With reference to FIG. 1, the flange portion 50 has a maximum length defined by a distance from the free distal end 31 of the first wall 34 to a free distal end 59 of the flange portion 50. As can be seen in FIG. 1, the maximum length of the flange portion 50 is greater than the maximum length of the first wall 34, although this need not be the case. In the exemplary embodiment of FIG. 1, the flange portion 50 has a maximum width defined by a distance from the first side 56 of the flange portion 50 to the second side 58 of the flange portion 50. Similarly, the first wall 34 has a maximum width defined by a distance from the first side 44 of the clip portion 32 to the second side 46 of the clip portion 32. In the illustrated embodiment, the maximum width of the first wall 34 is larger than the maximum width of the flange portion 50 (i.e., the flange portion 50 is not as wide as the clip portion 32). It will be appreciated that the relative lengths and widths of the first wall 34, second wall 36, and flange portion 50 of the leading edge protector 30 are shown by way of example only, and that these relative lengths and widths may be different in various embodiments of the leading edge protector 30.

The clip portion 32 includes at least one stand off or spacer 80. In the illustrated example, two spacers (stand-offs, ribs, ridges, or the like) 80 are illustrated as being included. In particular, as shown in FIGS. 2, the spacers 80 protrude from the second surface 27 of the second wall 36. In some embodiments, the spacers 80 are formed by being braised onto the second surface 27 of the second wall 36. In some embodiments, the spacers 80 may be formed (e.g., machined) into the second wall 36 of the clip portion 32. It will be appreciated that the spacers 80 may be formed on and/or attached to the second surface 27 of the second wall 36 of the clip portion 32 by any suitable means. While the clip portion 32 includes two spacers 80 in the embodiment illustrated in the drawings, it will be appreciated that the clip portion 32 may be configured to include any suitable number of spacers 80.

In the embodiment shown in FIG. 2, a width or profile of the spacer 80 increases from a first direction to a second direction. When installed, the first direction can be a forward direction. In other words, the forward end 82 of the spacer may have a smaller width than the back end 84 of the spacer 80. However, it will be appreciated that, in some embodiments, the spacer 80 may have a constant width from the forward end 82 to the back end 84.

As can be seen in FIGS. 1 and 2, each of the spacers 80 extends substantially along the length of the second wall 36. However, it will be appreciated that each of the spacers 80 may have a maximum length that is less than the maximum length of the second wall 36 such that each of the spacers 80 extends along only a portion of the length of the second wall 36.

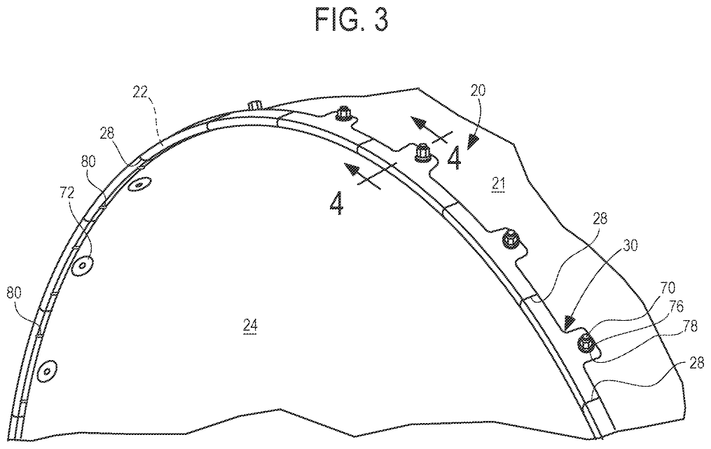

FIG. 3 illustrates a portion of exemplary protective liner 20 intended for attachment to and protection of an interior surface of an exhaust nozzle of an aircraft engine (e.g., a jet engine such as a turbofan engine, or the like). Since a typical exhaust nozzle of a jet engine has a generally cylindrical shape, the protective liner 20 shown in FIG. 1 has a generally cylindrical shape. In non-limiting examples, the protective liner 20 can be a CMC material forming a CMC liner and enclosing an interior 24 of the protective liner 20.

It will be understood that components of the gas turbine engine such as the liner may comprise a composite material, such as a ceramic matrix composite (CMC) material, which has high temperature capability. As used herein, CMC refers to a class of materials that include a reinforcing material (e.g., reinforcing fibers) surrounded by a ceramic matrix phase. Generally, the reinforcing fibers provide structural integrity to the ceramic matrix. Some examples of matrix materials of CMCs can include, but are not limited to, non-oxide silicon-based materials (e.g., silicon carbide, silicon nitride, or mixtures thereof), oxide ceramics (e.g., silicon oxycarbides, silicon oxynitrides, aluminum oxide (Al2O3), silicon dioxide (SiO2), aluminosilicates, or mixtures thereof), or mixtures thereof. Optionally, ceramic particles (e.g., oxides of Si, Al, Zr, Y, and combinations thereof) and inorganic fillers (e.g., pyrophyllite, wollastonite, mica, talc, kyanite, and montmorillonite) may also be included within the CMC matrix.

Some examples of reinforcing fibers of CMCs can include, but are not limited to, non-oxide silicon-based materials (e.g., silicon carbide, silicon nitride, or mixtures thereof), non-oxide carbon-based materials (e.g., carbon), oxide ceramics (e.g., silicon oxycarbides, silicon oxynitrides, aluminum oxide (Al2O3), silicon dioxide (SiO2), aluminosilicates such as mullite, or mixtures thereof), or mixtures thereof.

Generally, particular CMCs may be referred to as their combination of type of fiber/type of matrix. For example, C/SiC for carbon-fiber-reinforced silicon carbide; SiC/SiC for silicon carbide-fiber-reinforced silicon carbide, SiC/SiN for silicon carbide fiber-reinforced silicon nitride; SiC/SiC-SiN for silicon carbide fiber-reinforced silicon carbide/silicon nitride matrix mixture, etc. In other examples, the CMCs may be comprised of a matrix and reinforcing fibers comprising oxide-based materials such as aluminum oxide (Al2O3), silicon dioxide (SiO2), aluminosilicates, and mixtures thereof Aluminosilicates can include crystalline materials such as mullite (3Al2O3 2SiO2), as well as glassy aluminosilicates.

In certain embodiments, the reinforcing fibers may be bundled and/or coated prior to inclusion within the matrix. For example, bundles of the fibers may be formed as a reinforced tape, such as a unidirectional reinforced tape. A plurality of the tapes may be laid up together to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition.

Such materials, along with certain monolithic ceramics (i.e., ceramic materials without a reinforcing material), are particularly suitable for higher temperature applications. Additionally, these ceramic materials are lightweight compared to superalloys, yet can still provide strength and durability to the component made therefrom. Therefore, such materials are currently being considered for many gas turbine components used in higher temperature sections of gas turbine engines, such as airfoils (e.g., turbines, and vanes), combustors, shrouds and other like components, that would benefit from the lighter-weight and higher temperature capability these materials can offer.

FIG. 3 shows a protective liner 20 having a portion of the circumference of its forward-facing or leading edge 22 (i.e., the edge that is closer to the front of the aircraft engine) covered by a plurality of leading edge protectors 30 described above. The leading edge protectors 30 may be made of a metal or a metal alloy, or may be made of a non-metallic material suitable for protecting the leading edge of the protective liner 20 from direct impingement airflow in a high temperature environment typically present within an exhaust nozzle of an aircraft engine.

As shown in FIG. 3, the plurality of leading edge protectors 30 are designed to be arranged circumferentially in series around the entire circumference the leading edge 22 of the protective liner 20 although this need not be the case. When arranged around the leading edge 22 of the protective liner 20 substantially as shown in FIG. 3, the leading edge protectors 30 effectively protect the leading edge 22 of the protective liner 20 from the high temperature gases/fluids that flow into the interior of the exhaust nozzle and impinge the leading edge 22 of the protective liner 20. As such, the leading edge protectors 30 provide long-term deformation/delamination protection to the leading edge 22 of the protective liner 20 and thus provide prolonged protection to the interior surface of the metal duct of the aircraft engine exhaust nozzle.

It will be understood that optionally the leading edge protectors 30 are positioned in a segmented fashion as seen in FIG. 3 such that there is gap 28 between each pair of adjacent leading edge protectors 30. The segmented positioning of the leading edge protectors 30 around the leading edge 22 of the protective liner 20 with gaps 28 between the adjacent leading edge protectors 30 accommodates (i.e., provides additional room) for possible thermal expansion of the protective liner 20 and/or leading edge protectors 30 during operation of the aircraft engine.

In this manner, while the gaps 28 may be present at installation, the leading edge protectors 30 may cover an entire 360 degrees of the leading edge 22 based on known expansion of the plurality of leading edge protectors 30. It will be appreciated that the gap/space 28 between the adjacent leading edge protectors 30 shown in FIG. 3 is exemplary and not necessarily drawn to scale. Generally, the gap 28 may be of a size that is suitable to permit the adjacent leading edge protectors 30 to undergo some thermal expansion without impinging on each other, and the gap 28 may have varying application-specific sizes depending, for example, on the overall circumference of the protective liner 20. Also, depending on the size of an exhaust nozzle and diameter of the protective liner 20, twenty-four to forty-eight leading edge protectors 30 may be used to cover the entire leading edge 22 of a typical protective liner 20. It will be appreciated that less than 24 or more than 48 leading edge protectors 30 may be used in some embodiments.

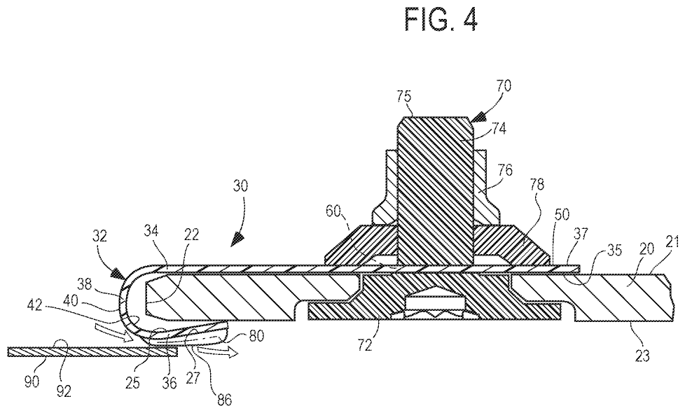

FIG. 4 illustrates an embodiment of a leading edge protector 30 attached to a leading edge 22 of the protective liner 20 and covering a portion of the protective liner 20 adjacent the leading edge 22. While reference is being made to a CMC liner 20 of a metal duct of an exhaust nozzle, it will be appreciated that the CMC liner 20 is just an exemplary material that may be used as a protective liner for the metal duct of the exhaust nozzle (or other metallic components of an aircraft engine), and that any similar non-metallic material (e.g., polymer matrix composite (PMC) or the like) suitable for lining the interior of the metal duct of the exhaust nozzle (by way of having thermal expansion properties suitable for a high temperature environment such as an interior of an aircraft engine) may be used instead Further still, the leading edge protector 30 is suitable for use on a variety of components including both aviation and ground.

With reference to FIG. 4, the leading edge protector 30, and more specifically, the flange portion 50 of the body 29 of the leading edge protector 30 is attached to the protective liner 20 by a fastener 70 (e.g., bolt or the like) that passes through the protective liner 20 and through the aperture 60 in the first surface 52 and second surface 54 of the flange portion 50. It will be appreciated, that in some embodiments, the leading edge protector 30 may be attached to the leading edge 22 of the protective liner 20 without the use of the specified fastener 70. It will be understood that any suitable attachment, fastening or the like can be utilized including, but not limited to, snap-fit, friction-fit, adhesive, welding, etc. However, it is beneficial to have the leading edge protector 30 attached via a single-point fastener 70 in order to minimize the thermal growth mismatch between the leading edge protector 30 and the protective liner 20, especially in instances where the leading edge protector 30 is a metal/metal alloy leading edge protector and the protective liner 20 is a CMC/PMC protective liner.

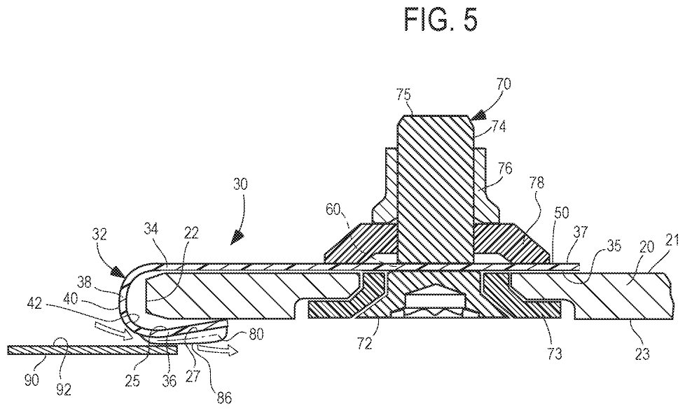

In the embodiment of FIG. 4, the head 72 of the fastener 70 is shaped and sized so that when the fastener 70 is installed, the head 72 of the fastener 70 is attached and recessed relative to the second surface 23 of the protective liner 20 such that no portion of the head 72 of the fastener 70 protrudes below the second surface 23 of the CMC liner 20, advantageously not exposing the metallic head 72 to the direct impingement by the high temperature gases passing through the interior 24 of the protective liner 20, and thereby protecting the head 72 of the fastener 70 from possible direct impingement by the hot exhaust gases passing through the interior 24 of the protective liner 20. In an alternative embodiment illustrated in FIG. 5, the head 72 of the fastener 70 is shaped differently (e.g., the fastener 70 may be a conventional countersunk bolt), and the fastener 70 is attached relative to the second surface 23 of the protective liner 20 via an insert 73 such that no portion of the head 72 of the fastener 70 and no portion of the insert 73 protrudes below the second surface 23 of the CMC liner 20, advantageously not exposing the metallic head 72 or the insert 73 (which may also be metallic) to the direct impingement by the high temperature gases passing through the interior 24 of the protective liner 20, and thereby protecting the head 72 of the fastener 70 and the insert 73 from possible direct impingement by the hot exhaust gases passing through the interior 24 of the protective liner 20.

In the embodiment illustrated in FIG. 4, the shaft 74 of the fastener passes through a portion of the protective liner 20 and passes through the aperture 60 of the flange portion 50 and extends above both the second surface 54 of the flange portion 50 and the first surface 21 of the protective liner 20, and is secured relative to the second surface 54 of the flange portion 50 and the outwardly-facing surface 21 of the protective liner 20 via a nut 76 (e.g., a self-locking nut). As shown in FIG. 4, the nut 76 may be tied onto a thermal spacer 78 (through which the threaded portion of the fastener 70 passes), which accommodates for possible thermal expansion of the leading edge protector 30 and/or protective liner 20 and/or the fastener 70, keeping the attachment of the leading edge protector 30 to the protective liner 20 more secure.

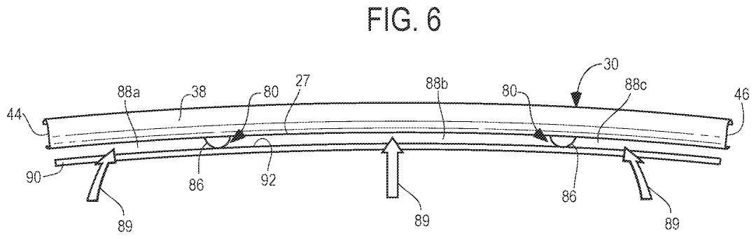

As shown, by way of example in FIGS. 4 and 6, the width and height and overall shape of the spacers 80 is selected such that, when a liner 90 that protects an upstream (i.e., more forward) portion of an aircraft (or a non-aircraft) engine is positioned in abutment with the leading edge protector 30 as shown in FIGS. 4 and 6, the generally horizontal outwardly-facing or first surface 92 of the upstream liner 90 abuts the inwardly-facing or first surface 86 of the spacers 80 (the first surface 86 of the spacers 80 having a generally horizontal contour that is complementary to the shape of the first surface 92 of the upstream liner 90), and such that that the first surface 92 of the upstream liner 90 is spaced from the second surface 27 of the second wall 36 to create one or more air flow gaps 88. The overall dimension/height of the spacers 80 may be selected based on the needs of a specific installation and, generally, the overall dimension/height of the spacers 80 may be selected to provide air flow gaps 88a, 88b, 88c (see FIG. 6) that are of a size that is suitable to provide significant amounts of cooling air to flow into the interior 24 of the protective liner 20.

In an exemplary leading edge protector 30 having two spacers 80 as shown in FIG. 6, when the upstream liner 90 is placed in abutment with the spacers 80, three air flow gaps 88a, 88b, 88c are created between the second surface 27 of the second wall 36 of the clip portion 32 of the leading edge protector 30 and the first surface 92 of the upstream liner 90. The air flow gaps 88a, 88b, 88c provided by the spacers 80 facilitate a consistent gap for uniform cooling air to flow (in the direction shown by arrows 89 in FIG. 6) into the interior 24 of the protective liner 20. This cooling air flow can lower the temperature of the exhaust gases and decrease the effect of the direct impingement of the exhaust gases onto the protective liner 20 and/or reduce the degree of thermal expansion of the protective liner 20, thereby reducing the possibility of delamination of the protective liner 20 and ensuring a longer life cycle for the protective liner 20. In this manner, the spacers 80 center the protective liner 20 during assembly and provide a consistent gap 88a-c between mating hardware, allowing uniform cooling air to enter the interior 24 of the protective liner 20.

As can be seen in FIGS. 4 and 6, the size and shape of the spacers 80 determines the size and shape of the air flow gaps 88a, 88a, 88c. For example, if the spacers 80 have a height of 20-50 mils, then the resulting air flow gap(s) 88 between the second surface 27 of the second wall 36 and the first surface 92 of the upstream liner 90 would be 20-50 mils. Depending on the sizes of components of a given engine, the spacers 80 may be increased in size to provide a higher volume cooling air flow into the interior 24 of the protective liner 20, or reduced in size to provide a lower volume cooling air flow into the interior of the protective liner 20.

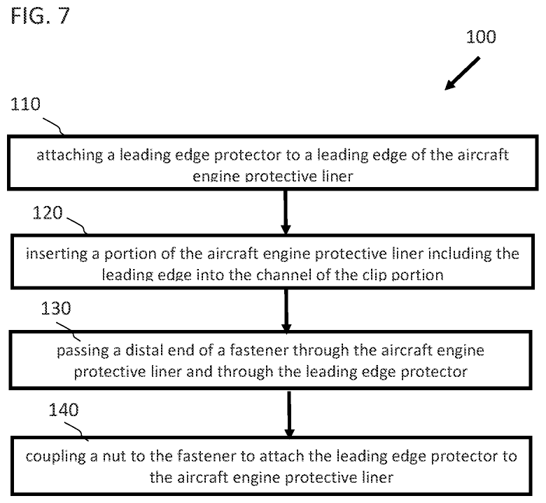

With reference to FIG. 7, an exemplary method 100 of protecting a leading edge 22 of a protective (e.g., CMC, PMC, or the like) liner 20 of an aircraft engine component (e.g., metal duct of an exhaust nozzle of the aircraft) will now be described. For exemplary purposes, the method 100 is described in the context of attaching the leading edge protector 30 to a leading edge 22 of a protective liner 20, but it will be understood that embodiments of the method 100 may be implemented to attach various other embodiments of the leading edge protector 30 to the leading edge 22 of the protective liner 20 (or to a leading edge of a different protective liner used to protect a (metallic or non-metallic) component of an aircraft exhaust nozzle or a (metallic or non-metallic) component of another (engine or non-engine) part of the aircraft.

In the non-limiting example provided in FIG. 7, the method 100 includes attaching a leading edge protector 30 including: a clip portion 32 including a channel 39 to a portion of the protective liner 20 including the leading edge 22 of the protective liner 20, the clip portion 32 including one or more spacers 80 extending therefrom (step 110). As pointed out above, the leading edge protector 80 may be made of a metal or a metal alloy, or may be made of a non-metallic material suitable for protecting the protective liner 20 from the high temperature environment typically present within an exhaust nozzle of an aircraft engine.

The method 100 further includes inserting a portion of the protective liner 20 including the leading edge 22 into the channel 39 of the clip portion 32 of the leading edge protector 30 such that a part of the clip portion 32 and the flange portion 50 overlie a portion of the first surface 21 of the protective liner 20 (step 120). As can be seen in FIG. 7, after step 120, with the leading edge 22 of the protective liner 20 being inserted into the channel 39 of the clip portion 32 of the leading edge protector 30 (as shown, e.g., in FIG. 4), at least a portion of the second wall 36 of the clip portion 32 of the leading edge protector 30 underlies a portion of the interior-facing surface 23 of the protective liner 20.

The method 100 of FIG. 7 further includes attaching the leading edge protector 30 to the protective liner 20 by way of passing a distal end 75 of a fastener 70 through the protective liner 20 and through the aperture 60 of the flange portion 50 of the leading edge protector 30 such that the distal end 75 of the fastener 70 protrudes above the flange portion 50 of the leading edge protector 30 (step 130). As can be seen in FIG. 4, the fastener 70 may be attached to the second surface 23 of the protective liner 20 directly (or via an insert 73), such that the head 72 of the fastener 70 (and, if present, the insert 73) is recessed relative to the second surface 23 of the protective liner 20, and such that no portion of the head 72 of the fastener 70 (and no portion of the insert 73) protrudes below the second surface 23 of the protective liner 20, advantageously not exposing the metallic head 72 of the fastener 70 or the insert 73 to direct impingement by the high temperature gases passing through the interior 24 of the protective liner 20, and thereby protecting the head 72 of the fastener 70 and the insert 73 from possible thermal expansion.

Following step 130, as seen in FIG. 4, the shaft 74 of the fastener passes through a portion of the protective liner 20 and passes through the aperture 60 of the flange portion 50 and extends above both the second surface 54 of the flange portion 50 and the first surface 21 of the protective liner 20. To attach the fastener 70 to the leading edge protector 30, the method 100 of FIG. 7 includes coupling a nut 76 to the shaft 74 of the fastener 70 (step 140). In some embodiments, the nut 76 is a self-locking nut, and a thermal spacer 78 is positioned between the nut 76 and the outwardly-facing surface 54 of the flange portion 50 to accommodate for possible thermal expansion of the leading edge protector 30 and/or protective liner 20 and/or the fastener 70, keeping the attachment of the leading edge protector 30 to the protective liner 20 more secure.

Further aspects of disclosure are provided by the subject matter of the following clauses:

A leading edge protector is provided, which includes: a body including: a clip portion including a channel for receiving a portion of a leading edge of an aircraft engine protective liner, wherein the clip portion includes at least one spacer extending therefrom; and a flange portion extending from the clip portion and including an aperture configured to receive a portion of a fastener that passes through the aperture and through at least a portion of the aircraft engine protective liner to attach the leading edge protector to the aircraft engine protective liner.

The clip portion of the leading edge protector may include a first side and a second side opposite the first side, and the channel may extend from the first side of the clip portion to the second side of the clip portion. The flange portion of the leading edge protector may have a first side and a second side opposite the first side, and a distance from the first side to the second side of the clip portion may be greater than a distance from the first side to the second side of the flange portion.

The clip portion of the leading edge protector may include a first wall, a second wall, and a third wall interconnecting the first wall and the second wall, wherein the first wall, the second wall, and the third wall may be U-shaped and may define the channel therebetween. The first wall of the leading edge protector may have a maximum length defined by a distance from the third wall to a free distal end of the first wall. The second wall of the leading edge protector may have a maximum length defined by a distance from the third wall to a free distal end of the second wall, and the maximum length of the first wall may be greater than the maximum length of the second wall. The at least one spacer may extend along an entire maximum length of the second wall.

The flange portion of the leading edge protector may have a maximum length defined by a distance from the free distal end of the first wall to a free distal end of the of the flange portion, and the maximum length of the flange portion may be greater than the maximum length of the first wall. The body may be made of a metal or metal alloy material.

The clip portion and the flange portion of the leading edge protector may be unitarily formed. The body of the leading edge protector may have a first, inwardly-facing surface, and a second, outwardly-facing surface.

A system for protecting a leading edge of an aircraft engine protective liner is also provided. The system includes a plurality of leading edge protectors. At least one leading edge protector of the plurality of leading edge protectors includes: a body including: a clip portion including a channel configured to receive a portion of a leading edge of the aircraft engine protective liner, therein, the clip portion including at least one spacer extending therefrom; and

a flange portion extending from the clip portion along a portion of the aircraft engine protective liner and including an aperture; and a fastener passing through the aperture of the flange portion and through at least a portion of the aircraft engine protective liner to attach the at least one leading edge protector to the aircraft engine protective liner.

In the system, the clip portion of the at least one leading edge protector may include a first side and a second side opposite the first side, and the channel may extend from the first side of the clip portion to the second side of the clip portion.

In the system, the flange portion of the at least one leading edge protector may have a first side and a second side opposite the first side, and a distance from the first side to the second side of the clip portion may be greater than a distance from the first side to the second side of the flange portion.

In the system, the clip portion of the at least one leading edge protector may include a first wall, a second wall, and a third wall interconnecting the first wall and the second wall, and the first wall, the second wall, and the third wall may be U-shaped and may define the channel therebetween.

In the system, the first wall of the at least one leading edge protector may have a maximum length defined by a distance from the third wall to a free distal end of the first wall, and the second wall may have a maximum length defined by a distance from the third wall to a free distal end of the second wall, and the maximum length of the first wall may be greater than the maximum length of the second wall. In addition, the flange portion of the at least one leading edge protector may have a maximum length defined by a distance from the free distal end of the first wall to a free distal end of the of the flange portion, and the maximum length of the flange portion may be greater than the maximum length of the first wall. The second wall of the at least one leading edge protector may have a maximum length defined by a distance from the third wall to a free distal end of the second wall, and the at least one spacer may extend along an entire maximum length of the second wall.

In the system, a head of the fastener may be recessed in the aircraft engine protective liner such that no portion of the head of the fastener protrudes inwardly beyond an interior-facing surface of the aircraft engine protective liner.

In the system, the at least one leading edge protector may be made of a metal or metal alloy material, and the aircraft engine protective liner may be made of a ceramic matrix material or a polymer matrix composite material.

In the system, the leading edge protectors may be arrayed on the leading edge of the aircraft engine protective liner to provide full 360° protection of the leading edge of the aircraft engine protective liner against direct airflow impingement.

In the system, the at least one spacer may be a plurality of spacers positioned between the aircraft engine protective liner and a mating liner to provide a plurality of air flow gaps between the aircraft engine protective liner and the mating liner.

A method of protecting a leading edge of an aircraft engine protective liner is also provided. The method includes attaching a leading edge protector to the aircraft engine protective liner. The leading edge protector has a body including a clip portion including a channel configured to receive a portion of a leading edge of the aircraft engine protective liner, the clip portion including at least one spacer extending therefrom; and a flange portion extending from the clip portion along a portion of the aircraft engine protective liner and including an aperture. The method further includes passing a fastener through the aperture of the flange portion and through at least a portion of the aircraft engine protective liner; and coupling a nut to the fastener to secure the leading edge protector to the aircraft engine protective liner.

As described above, the spacers 80 of the exemplary leading edge protectors 30 described herein ensure uniform air flow gaps 88a-c between the leading edge 22 of the protective liner 20 (which may protect, for example, the interior surface of an exhaust nozzle of an aircraft of another engine) and the outwardly-facing or first surface 92 of a liner 90 positioned upstream of the exhaust nozzle. These gaps 88 advantageously provide passages for the flow of cooling air from an upstream portion of the engine into the interior of the exhaust nozzle and into the interior 24 of the protective liner 20, thereby reducing the temperature of the gases/fluids that pass through the interior 24 of the protective liner 20, and reducing the heat exerted onto the leading edge protector 30 and/or the interior-facing surface 23 of the protective liner 20. As a result, the direct impingement of the protective liner 20 by hot air flow and the extent of possible thermal expansion of the protective liner 20 are advantageously reduced, and possible delamination of the protective liner 20 and/or possible thermal expansion of the protective liner 20 are significantly minimized, thereby greatly increasing the service life of the protective liner 20. In addition, the leading edge protectors 30 are capable of being arrayed in a circular pattern and attached to the forward-facing surface 22 of the protective liner 20 to provide full 360° protection to the forward-facing surface 22 of the protective liner 20. The segmented nature of the installation of the leading edge protectors onto the forward-facing surface 22 of the protective liner 20, in combination with the leading edge protectors 30 being attached to the protective liner 20 via a single point advantageously accommodate for possible thermal growth mismatch between the CMC/PMC protective liner 20 and the metal/metal alloy leading edge protector 30

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A leading edge protector, comprising:
a body including:
a clip portion including a channel for receiving a portion of a leading edge of an aircraft engine protective liner,
at least a first spacer and a second spacer integrally formed with the clip portion by being braised onto or machined into a surface of the clip portion such that each of the at least one first spacer and second spacer defines a protrusion integrally formed on the surface of the clip portion, wherein the first spacer is spaced from the second spacer on the clip portion; and
a flange portion extending from the clip portion and including an aperture configured to receive a portion of a fastener that passes through the aperture and through at least a portion of the aircraft engine protective liner to attach the leading edge protector to the aircraft engine protective liner.

2. The leading edge protector of claim 1, wherein the clip portion includes a first side and a second side opposite the first side, the channel extending from the first side of the clip portion to the second side of the clip portion.

3. The leading edge protector of claim 2, wherein the flange portion has a first side and a second side opposite the first side, and wherein a distance from the first side to the second side of the clip portion is greater than a distance from the first side to the second side of the flange portion.

4. The leading edge protector of claim 1, wherein the clip portion includes a first wall, a second wall, and a third wall interconnecting the first wall and the second wall, wherein the first wall, the second wall, and the third wall are U-shaped and define the channel therebetween.

5. The leading edge protector of claim 4,
wherein the first wall has a maximum length defined by a distance from the third wall to a free distal end of the first wall;
wherein the second wall has a maximum length defined by a distance from the third wall to a free distal end of the second wall, the maximum length of the first wall being greater than the maximum length of the second wall; and
wherein each of the first spacer and the second spacer extends along an entire maximum length of the second wall.

6. The leading edge protector of claim 5, wherein the flange portion has a maximum length defined by a distance from the free distal end of the first wall to a free distal end of the of the flange portion, the maximum length of the flange portion being greater than the maximum length of the first wall.

7. The leading edge protector of claim 1, wherein the body is made of a metal or metal alloy material.

8. The leading edge protector of claim 1, wherein the clip portion and the flange portion are unitarily formed.

9. The leading edge protector of claim 1, wherein the body has a first, inwardly-facing surface, and a second, outwardly-facing surface.

10. A system comprising:
an aircraft engine protective liner having a leading edge;
a plurality of leading edge protectors, at least one leading edge protector of the plurality of leading edge protectors including:
a body including:
a clip portion including a channel for receiving a portion of a leading edge of an aircraft engine protective liner,
at least a first spacer and a second spacer integrally formed with the clip portion by being braised onto or machined into a surface of the clip portion such that each of the at least one first spacer and second spacer defines a protrusion integrally formed on the surface of the clip portion, wherein the first spacer is spaced from the second spacer on the clip portion; and
a flange portion extending from the clip portion along a portion of the aircraft engine protective liner and including an aperture; and
a fastener passing through the aperture of the flange portion and through at least a portion of the aircraft engine protective liner to attach the at least one leading edge protector to the aircraft engine protective liner.

11. The system of claim 10, wherein the clip portion includes a first side and a second side opposite the first side, the channel extending from the first side of the clip portion to the second side of the clip portion.

12. The system of claim 10, wherein the clip portion includes a first wall, a second wall, and a third wall interconnecting the first wall and the second wall, wherein the first wall, the second wall, and the third wall are U-shaped and define the channel therebetween.

13. The system of claim 12, wherein the first wall has a maximum length defined by a distance from the third wall to a free distal end of the first wall, and wherein the second wall has a maximum length defined by a distance from the third wall to a free distal end of the second wall, the maximum length of the first wall being greater than the maximum length of the second wall.

14. The system of claim 13, wherein the flange portion has a maximum length defined by a distance from the free distal end of the first wall to a free distal end of the of the flange portion, the maximum length of the flange portion being greater than the maximum length of the first wall.

15. The system of claim 12, wherein the second wall has a maximum length defined by a distance from the third wall to a free distal end of the second wall, and wherein each of the first spacer and the second spacer extends along an entire maximum length of the second wall.

16. The system of claim 10, wherein a head of the fastener is recessed in the aircraft engine protective liner such that no portion of the head of the fastener protrudes inwardly beyond an interior-facing surface of the aircraft engine protective liner.

17. The system of claim 10, wherein the at least one leading edge protector is made of a metal or metal alloy material.

18. The system of claim 10, wherein the aircraft engine protective liner is made of a ceramic matrix material or a polymer matrix composite material.

19. The system of claim 10, wherein the leading edge protectors are arrayed on the leading edge of the aircraft engine protective liner to provide full 360° protection of the leading edge of the aircraft engine protective liner against direct airflow impingement.

20. (canceled)

21. The system of claim 11, wherein the flange portion has a first side and a second side opposite the first side, and wherein a distance from the first side to the second side of the clip portion is greater than a distance from the first side to the second side of the flange portion.
